(19) United States
(12) Patent Application Publication
(10) Pub. No.: US 2018/0155108 A1
(43) Pub. Date: Jun. 7, 2018

(54) Cutting Board and Container Combination Assembly

(71) Applicant: William Jenkins, Ypsilanti, MI (US)

(72) Inventor: William Jenkins, Ypsilanti, MI (US)

(21) Appl. No.: 15/367,756

(22) Filed: Dec. 2, 2016

(51) Int. Cl. B65D 81/36; A47J 47/10; B65D 43/02; B65D 25/28; A47J 47/00

(52) U.S. Cl. CPC B65D 81/36; A47J 47/10; A47J 47/005; B65D 25/28; B65D 43/0202

(57) ABSTRACT

A cutting board and container combination assembly includes a base having a top side, a bottom side and a perimeter edge. The base is comprised of a rigid material. A flange is attached to and extending outwardly from the perimeter edge. The flange is coextensive with the perimeter edge and extends completely around the top side. A cutting board is positioned on and attached to the top side. A cover is provided and is removably positioned over and covering the top side. The cover includes a top wall and a perimeter wall is attached to and extending downwardly from the top wall. The perimeter wall has a bottom edge that is positioned on the flange.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to food container devices and more particularly pertains to a new food container device for providing a preparation area for cutting a food product wherein the food product may be covered and preserved while remaining on the preparation area.

### BRIEF SUMMARY OF THE INVENTION

An embodiment of the disclosure meets the needs presented above by generally comprising a base having a top side, a bottom side and a perimeter edge. The base is comprised of a rigid material. A flange is attached to and extending outwardly from the perimeter edge. The flange is coextensive with the perimeter edge and extends completely around the top side. A cutting board is positioned on and attached to the top side. The cutting board is comprised of a wood material or a plastic material. A cover is provided and is removably positioned over and covering the top side. The cover includes a top wall and a perimeter wall is attached to and extending downwardly from the top wall. The perimeter wall has a bottom edge that is positioned on the flange.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a cutting board and container combination assembly according to an embodiment of the disclosure.

FIG. 2 is a bottom view of an embodiment of the disclosure.

FIG. 3 is a side view of an embodiment of the disclosure.

FIG. 4 is a perspective top view of an embodiment of the disclosure.

FIG. 5 is a cross-sectional view taken along line 5-5 of an embodiment of the disclosure.

### DETAILED DESCRIPTION OF THE INVENTION

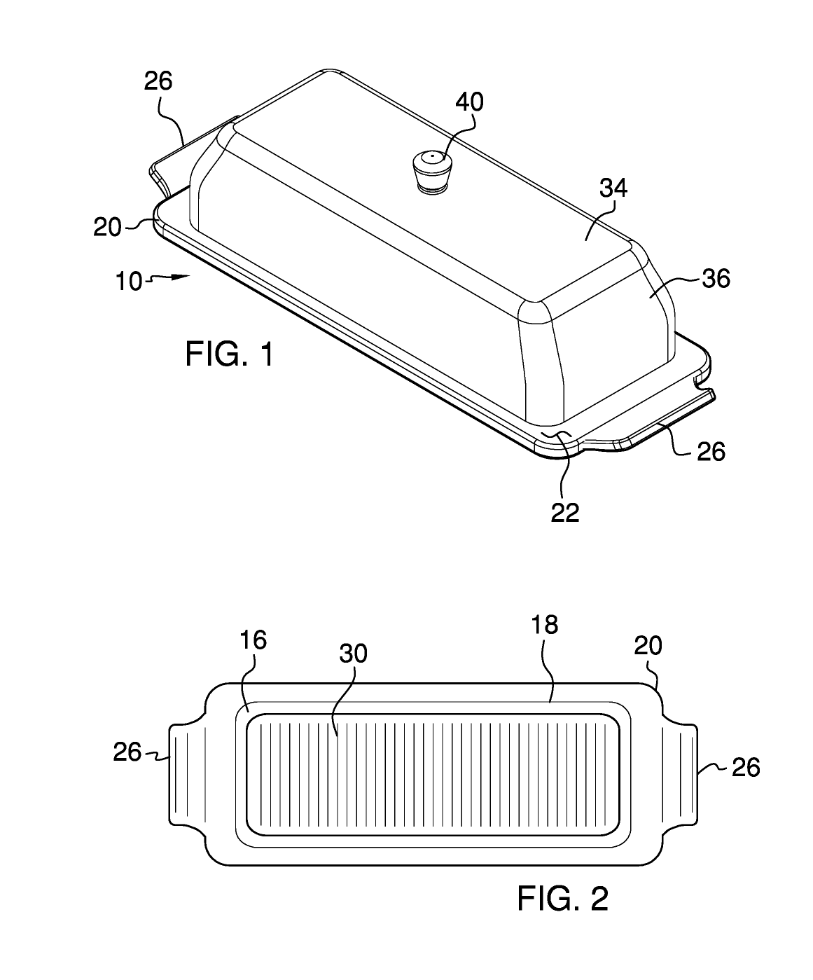

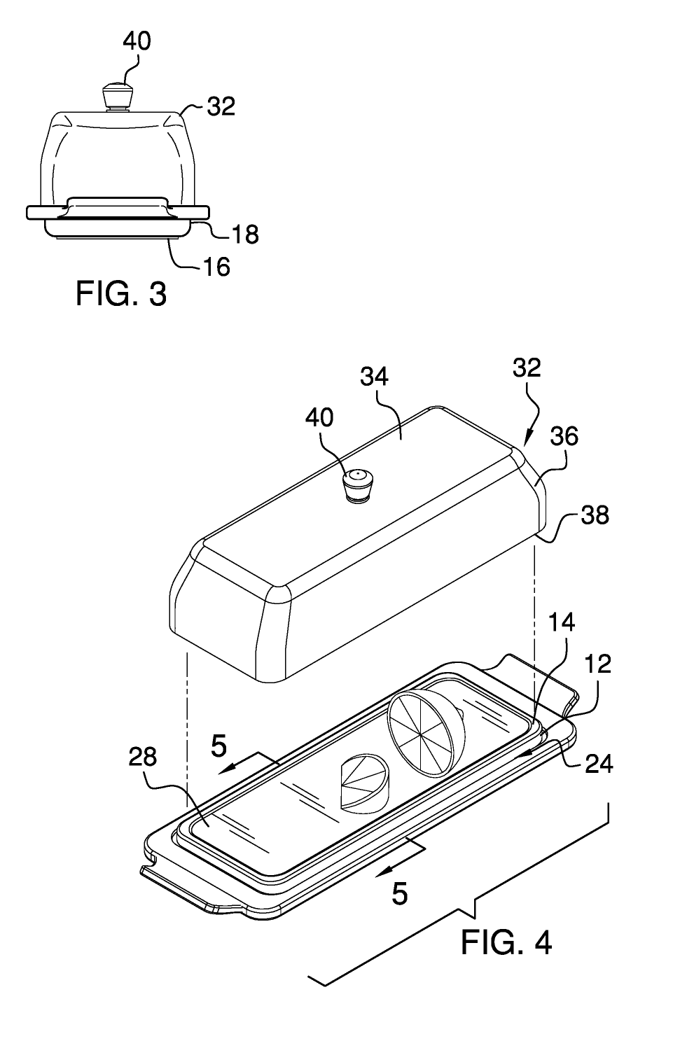

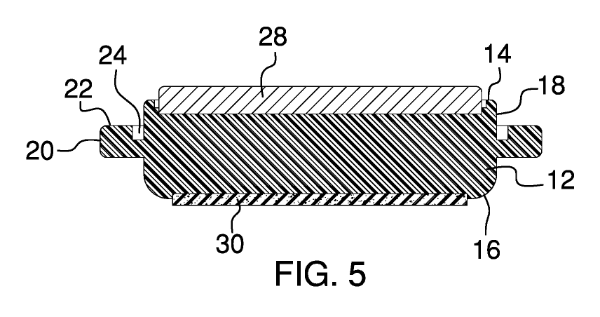

With reference now to the drawings, and in particular to FIGS. 1 through 5 thereof, a new food container device embodying the principles and concepts of an embodiment of the disclosure and generally designated by the reference numeral 10 will be described.

As best illustrated in FIGS. 1 through 5, the cutting board and container combination assembly 10 generally comprises a base 12 having a top side 14, a bottom side 16 and a perimeter edge 18. The base 12 is comprised of a rigid material which may include a plastic, would, metal, composite or other rigid material. The base 12 has a length between 4.0 inches and 12.0 inches and a width between 3.0 inches and 6.0 inches. The base 12 may have a height from the top side 14 to the bottom side 16 that is between 0.5 inches and 2.0 inches.

A flange 20 is attached to and extends outwardly from the perimeter edge 18 a distance of less than 1.0 inches. The flange 20 is coextensive with the perimeter edge 18 and extends completely around the top side 14. The flange 20 has an upper surface 22 and the upper surface 22 has a trough 24 therein extending completely around the base 12. The trough 24 may be positioned adjacent to the perimeter edge 18 and the flange 20 may be spaced from the top side 14. At least one handle 26 may be attached to and extend away from the flange 20. The handle 26 may be curved or angled upwardly from the flange 20 to provide for easier gripping of the handle 26.

A cutting board 28 is positioned on and attached to the top side 14. The cutting board 28 may be comprised of any material conventionally used for cutting boards such that a knife is not damaged when used for cutting various foods on the cutting board 28. Particularly, the cutting board 28 may therefore be comprised of a wood material or a plastic material. The plastic material may be a high density polyethylene material.

A non-slip panel 30 is attached to the bottom side 16 of the base 12. The non-slip panel 30 is comprised of an elastomeric material and may be tacky. The non-slip panel 30 may include a plurality of traction grooves for increasing the traction of the non-slip panel 30 with a countertop on which the assembly 10 may be positioned.

A cover 32 is provided and is removably positioned over and covers the top side 14. The cover 32 includes a top wall 34 and a perimeter wall 36 that is attached to and extends downwardly from the top wall 34. The perimeter wall 36 has a bottom edge 38 and the bottom edge 38 is positioned on the flange 22. More particularly, the bottom edge 22 is removably extendable into the trough 24. The trough 24 may include side walls that frictionally engage the perimeter wall 36 such that an airtight seal is formed with the cover 32 to protect any food products positioned on the cutting board 28. A grip 40 may be attached to the cover 32. The grip 40 is positioned on and extending upwardly from the top wall 34.

In use, food products, particularly fruits, cheeses and the like, may be cut on the cutting board 28 and then those portions not immediately consumed may be enclosed with the cover 32. The non-slip panel 30 prevents the base 12 from sliding or moving easily across a countertop while food products are being cut on the cutting board 28. The assembly 10 may then be stored in the refrigerator with food products positioned thereon and the cut food products thereafter accessed as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food cutting surface and container combination assembly comprising:
a base having a top side, a bottom side and a perimeter edge, said base being comprised of a rigid material;
a flange being attached to and extending outwardly from said perimeter edge, said flange being coextensive with said perimeter edge and extending completely around said top side;
a cutting board being positioned on and attached to said top side, said cutting board being comprised of a wood material or a plastic material; and
a cover being provided and being removably positioned over and covering said top side, said cover including a top wall and a perimeter wall being attached to and extending downwardly from said top wall, said perimeter wall having a bottom edge, said bottom edge being positioned on said flange.

2. The food cutting surface and container combination assembly according to claim 1, wherein said base has a length between 4.0 inches and 12.0 inches and a width between 3.0 inches and 6.0 inches.

3. The food cutting surface and container combination assembly according to claim 1, wherein said upper surface has a trough therein extending completely around said base, said bottom edge of said perimeter wall being removably extendable into said trough.

4. The food cutting surface and container combination assembly according to claim 1, further including a non-slip panel being attached to said bottom side of said base.

5. The food cutting surface and container combination assembly according to claim 4, wherein said non-slip panel is comprised of an elastomeric material.

6. The food cutting surface and container combination assembly according to claim 1, further including a grip being attached to said cover.

7. The food cutting surface and container combination assembly according to claim 6, wherein said grip is positioned on and extending upwardly from said top wall.

8. The food cutting surface and container combination assembly according to claim 1, further including at least one handle being attached to and extending away from said flange.

9. The food cutting surface and container combination assembly according to claim 3, further including a non-slip panel being attached to said bottom side of said base.

10. The food cutting surface and container combination assembly according to claim 3, further including a grip being attached to said cover.

11. The food cutting surface and container combination assembly according to claim 3, further including at least one handle being attached to and extending away from said flange.

12. A food cutting surface and container combination assembly comprising:
a base having a top side, a bottom side and a perimeter edge, said base being comprised of a rigid material, said base having a length between 4.0 inches and 12.0 inches and a width between 3.0 inches and 6.0 inches, said base having a height from said top side to said bottom side being between 0.5 inches and 2.0 inches;
a flange being attached to and extending outwardly from said perimeter edge, said flange being coextensive with said perimeter edge and extending completely around said top side, said flange having an upper surface, said upper surface having a trough therein extending completely around said base;
a cutting board being positioned on and attached to said top side, said cutting board being comprised of a wood material or a plastic material;
a non-slip panel being attached to said bottom side of said base, said non-slip panel being comprised of an elastomeric material;
a cover being provided and being removably positioned over and covering said top side, said cover including a top wall and a perimeter wall being attached to and extending downwardly from said top wall, said perimeter wall having a bottom edge, said bottom edge being positioned on said flange, said bottom edge being removably extendable into said trough;
a grip being attached to said cover, said grip being positioned on and extending upwardly from said top wall; and
at least one handle being attached to and extending away from said flange.
